(19) United States
(12) Patent Application Publication
(10) Pub. No.: US 2010/0251996 A1
(43) Pub. Date: Oct. 7, 2010

(54) POWER OUTPUT APPARATUS, HYBRID VEHICLE PROVIDED WITH SAME, AND CONTROL METHOD OF POWER OUTPUT APPARATUS

(75) Inventor: Hikokazu Akimoto, Aichi-ken (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/750,753

(22) Filed: Mar. 31, 2010

(30) Foreign Application Priority Data
Apr. 1, 2009 (JP) JP2009-089284

(51) Int. Cl. F02P 5/00; F01N 3/10; F01N 9/00

(52) U.S. Cl. 123/406.23; 60/299; 60/286; 180/65.275

(57) ABSTRACT

A power output apparatus that outputs power to a drive shaft includes an internal combustion engine, an exhaust gas control apparatus, an electric motor, a power storage device, a required torque setting portion, a required power setting portion, an allowable discharge electric power setting portion, and a control portion that controls the internal combustion engine and the electric motor such that the internal combustion engine is operated at a preset catalyst warm-up operating point and torque that is based on a set required torque is output to the drive shaft, when a set required power is equal to or less than a set allowable discharge electric power when catalyst warm-up to promote activation of a catalyst needs to be executed.

### INCORPORATION BY REFERENCE

The disclosure of Japanese Patent Application No. 2009-089284 filed on Apr. 1, 2009 including the specification, drawings and abstract is incorporated herein by reference in its entirety.

### BACKGROUND OF THE INVENTION

1. Field of the Invention

The invention relates to a power output apparatus, a hybrid vehicle provided with that power output apparatus, and a control method of a power output apparatus.

2. Description of the Related Art

Japanese Patent Application Publication No. 2008-284909 (JP-A-2008-284909) describes a hybrid vehicle. When a low SOC control command is output but a catalyst warm-up command is not, the hybrid vehicle increases the allowable electric power for charging the battery, with the center of control of the state-of-charge (SOC) of the battery being a smaller value than normal. When a catalyst warm-up command is output, priority is given to warming up the catalyst so the engine is operated on its own (operating with no load) at idle speed with the ignition being retarded, irrespective of the low SOC control command. Also, Japanese Patent Application Publication No. 2002-130030 (JP-A-2002-130030) describes a hybrid vehicle that combines engine-driving with motor-driving. This hybrid vehicle operates the engine stably at a warm-up target output while using mainly the motor to provide the required output and changes therein for the vehicle until a first stage catalytic converter provided downstream of an exhaust manifold reaches a predetermined warm-up temperature T1. After the first stage catalytic converter has reached the predetermined warm-up temperature T1, the engine is operated to increase the output according to a command, while limiting the output increase speed until a second stage catalytic converter reaches a predetermined warm-up temperature T2. Then the amount of fuel supplied to the engine is increased or decreased based on data that is input thereafter. Japanese Patent Application Publication No. 2006-070820 (JP-A-2006-070820) describes another hybrid vehicle. In this hybrid vehicle, when the engine is started and there is a command to warm-up the catalyst, the engine is operated in a warm-up operating state in which the ignition timing is retarded and the intake air amount is increased by increasing the throttle opening amount in order to warm up the catalyst. When the catalyst has finished warming up, the throttle amount that had been adjusted to warm up the catalyst is kept fixed, while the retard of the ignition timing is canceled (i.e., the ignition timing is advanced). Once the retard of the ignition timing has been canceled, the throttle opening amount is allowed to be changed.

With a hybrid vehicle such as that described above, when the catalyst needs to be warmed up, i.e., when catalyst warm-up needs to be executed, activation of the catalyst can be promoted by operating the engine at an operating point suitable for warming up the catalyst by providing the required power using the electric power from the motor, i.e., the battery. However, if the power required when catalyst warm-up needs to be executed is not able to be provided entirely by the electric power from the battery, then the output, i.e., load, of the engine has to be increased even if the catalyst has not yet finished warming up. As a result, emissions may deteriorate.

### SUMMARY OF THE INVENTION

The power output apparatus, the hybrid vehicle provided with that power output apparatus, and the control method of the power output apparatus of the invention inhibit the deterioration of emissions by promoting the activation of a catalyst, even if the load of an internal combustion engine is increased due to the power required when catalyst warm-up needs to be executed not being able to be provided entirely by the electric power from a power storage device.

A first aspect of the invention relates to a power output apparatus that outputs power to a drive shaft. This power output apparatus includes an internal combustion engine that outputs power to the drive shaft; an exhaust gas control apparatus that includes a catalyst for purifying exhaust gas discharged from the internal combustion engine; an electric motor that outputs power to the drive shaft; a power storage device that supplies and receiving electric power to and from the electric motor; a required torque setting portion that sets a required torque that is required at the drive shaft; a required power setting portion that sets a required power that is power required to output the required torque to the drive shaft, based on the set required torque; an allowable discharge electric power setting portion that sets an allowable discharge electric power that is allowed to be discharged by the power storage device, based on the state of the power storage device; and a control portion that controls the internal combustion engine and the electric motor such that the internal combustion engine is operated at a preset catalyst warm-up operating point and torque that is based on the set required torque is output to the drive shaft, when the set required power is equal to or less than the set allowable discharge electric power when catalyst warm-up to promote activation of the catalyst needs to be executed, and controls the internal combustion engine and the electric motor such that the internal combustion engine is operated at an operating point that is based on the set required power with at least one of i) a retard correction of an ignition timing, ii) an increase correction of an intake air amount, or iii) a decrease correction of a fuel supply amount, and torque that is based on the set required torque is output to the drive shaft, when the set required power exceeds the set allowable discharge electric power when the catalyst warm-up needs to be executed.

With this power output apparatus, when the set required power is equal to or less than the set allowable discharge electric power when catalyst warm-up to promote activation of the catalyst needs to be executed, the internal combustion engine and the electric motor are controlled such that the internal combustion engine is operated at a preset catalyst warm-up operating point and torque that is based on the set required torque is output to the drive shaft. On the other hand, when the set required power exceeds the set allowable discharge electric power when the catalyst warm-up needs to be executed, the internal combustion engine and the electric motor are controlled such that the internal combustion engine is operated at an operating point that is based on the set required power with at least one of i) a retard correction of the ignition timing, ii) an increase correction of the intake air amount, or iii) a decrease correction of the fuel supply amount, and torque that is based on the set required torque is output to the drive shaft. In this way, if the required power exceeds the allowable discharge electric power such that the required power is no longer able to be met by the electric power from the power storage device when catalyst warm-up needs to be executed, activation of the catalyst can be promoted, which enables the deterioration of emissions to be suppressed, even if the power from the internal combustion engine does not quite meet the required power, by increasing the exhaust gas temperature of the internal combustion engine, which is achieved by operating the internal combustion engine at an operating point that is based on the required power with at least one of the retard correction of the ignition timing, the increase correction of the intake air amount, or the decrease correction of the fuel supply amount.

A second aspect of the invention relates to a control method of a power output apparatus. Here, the power output apparatus includes a drive shaft, an internal combustion engine that outputs power to the drive shaft, an exhaust gas control apparatus that includes a catalyst for purifying exhaust gas discharged from the internal combustion engine, an electric motor that outputs power to the drive shaft, and a power storage device supplies and receives electric power to and from the electric motor. This control method includes setting a required torque that is required at the drive shaft; setting a required power that is power required to output the required torque to the drive shaft, based on the set required torque; setting an allowable discharge electric power that is allowed to be discharged by the power storage device, based on the state of the power storage device; and controlling the internal combustion engine and the electric motor such that the internal combustion engine is operated at a preset catalyst warm-up operating point and torque that is based on the set required torque is output to the drive shaft, when the set required power is equal to or less than the set allowable discharge electric power when catalyst warm-up to promote activation of the catalyst needs to be executed, and controlling the internal combustion engine and the electric motor such that the internal combustion engine is operated at an operating point that is based on the set required power with at least one of i) a retard correction of an ignition timing, ii) an increase correction of an intake air amount, or iii) a decrease correction of a fuel supply amount, and torque that is based on the set required torque is output to the drive shaft, when the set required power exceeds the set allowable discharge electric power when the catalyst warm-up needs to be executed.

According to this method, if the required power exceeds the allowable discharge electric power such that the required power is no longer able to be met by the electric power from the power storage device when catalyst warm-up needs to be executed, activation of the catalyst can be promoted, which enables the deterioration of emissions to be suppressed, even if the power from the internal combustion engine does not quite meet the required power, by increasing the exhaust gas temperature of the internal combustion engine, which is achieved by operating the internal combustion engine at an operating point that is based on the required power with at least one of the retard correction of the ignition timing, the increase correction of the intake air amount, or the decrease correction of the fuel supply amount.

### BRIEF DESCRIPTION OF THE DRAWINGS

The foregoing and further features and advantages of the invention will become apparent from the following description of preferred embodiments with reference to the accompanying drawings, wherein like numerals are used to represent like elements and wherein:

FIG. 1 is a block diagram schematically showing a hybrid vehicle according to an example embodiment of the invention;

FIG. 2 is a block diagram schematically of an engine according to the example embodiment;

FIG. 3 is a flowchart illustrating an example of a drive control routine when warming up a catalyst that is executed by a hybrid ECU of the example embodiment;

FIG. 4 is a view of an example of a map for setting the required torque;

FIG. 5 is a view of one example of an alignment graph that shows the dynamic relationship between the rotation speed and torque of rotating elements of a power splitting/combining device;

FIG. 6 is a view showing an example of an engine operating line and a correlation curve between speed and torque; and

FIG. 7 is a block diagram schematically showing a hybrid vehicle according to a modified example of the example embodiment of the invention.

### DETAILED DESCRIPTION OF EMBODIMENTS

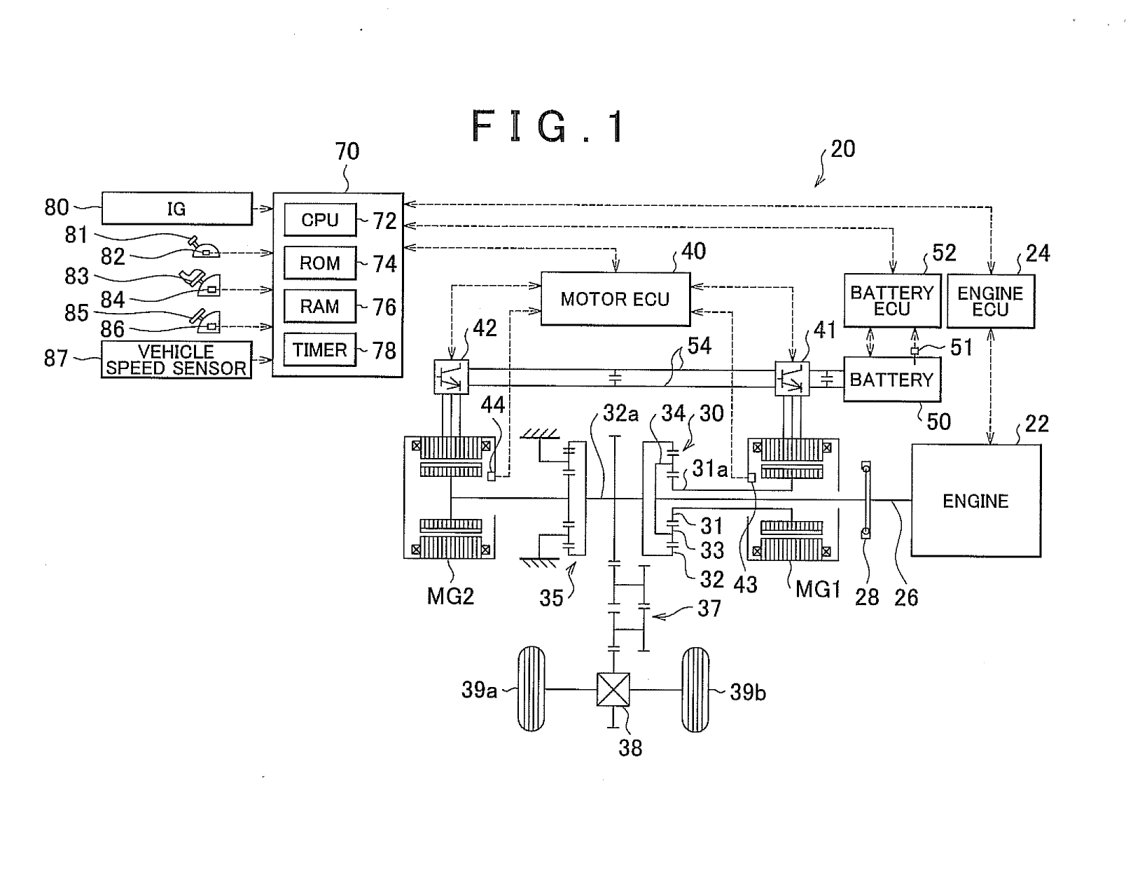

FIG. 1 is a block diagram schematically showing a hybrid vehicle 20 according to an example embodiment of the invention. The hybrid vehicle 20 shown in the drawing is provided with an engine 22, a three shaft-type power splitting/combining device 30 that is connected via a damper 28 to a crankshaft 26 that is an output shaft of the engine 22, a motor MG1 that is able to generate power and is connected to the power splitting/combining device 30, a reduction gear 35 that is connected to a ring gear shaft 32a that serves as a drive shaft that is connected to the power splitting/combining device 30, a motor MG2 that is connected to the ring gear shaft 32a via this reduction gear 35, and a hybrid electronic control unit (hereinafter, simply referred to as “hybrid ECU”) 70 that controls the overall hybrid vehicle 20, and the like.

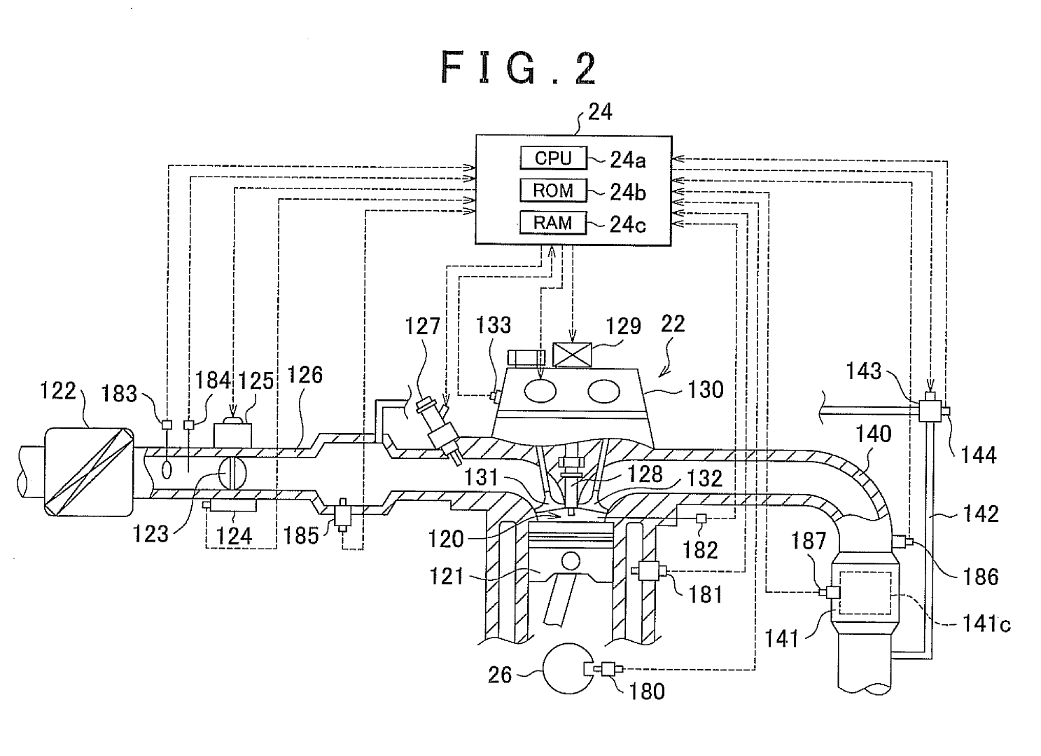

The engine 22 is an internal combustion engine that outputs power by combusting a mixture of a hydrocarbon fuel, such as gasoline or light oil, and air inside a combustion chamber 120, and converting the reciprocating motion of a piston 121 that results from the combustion of the air-fuel mixture into rotary motion of the crankshaft 26. In this engine 22, air that has been cleaned by an air-cleaner 122 is drawn into an intake pipe 126 via a throttle valve 123, and fuel such as gasoline is injected from a fuel injection valve 127 into this intake air, as is evident from FIG. 2. The thus obtained air-fuel mixture is then drawn into the combustion chamber 120 via an intake valve 131 that is driven by a valve mechanism 130 structured as a variable valve timing mechanism, and ignited by an electric spark from a spark plug 128 so that it combusts. Exhaust gas from the engine 22 is delivered via an exhaust valve 132 and an exhaust manifold 140 to an exhaust gas control apparatus 141 that includes an exhaust gas control catalyst (i.e., a three-way catalyst) 141c that purifies harmful components such as carbon monoxide (CO), hydrocarbons (HC), and oxides of nitrogen (NOx). After being purified by the exhaust gas control apparatus 141, the exhaust gas is discharged outside. Also, the engine 22 includes an EGR passage 142 that is connected to the exhaust passage downstream of the exhaust gas control apparatus 141 and circulates exhaust gas to a surge tank (i.e., the intake system), an EGR valve 143 that is provided midway in this EGR passage 142 and adjusts the recirculation amount (i.e., the EGR amount) of exhaust gas (i.e., EGR gas) that is circulated from the exhaust system to the intake system, and a temperature sensor 144 that detects the temperature of the EGR gas inside the EGR passage 142, and the like.

The engine 22 structured in this way is controlled by an engine electronic control unit (hereinafter, simply referred to as an “engine ECU”) 24. As shown in FIG. 2, the engine ECU 24 is formed as a microprocessor that is centered around a CPU 24a, and includes, in addition to the CPU 24a, ROM 24b that stores various processing programs, RAM 24c that temporarily stores data, and input/output ports and a communication port, not shown, and the like. Signals from various sensors that detect the state of the engine 22 and the like are input to the engine ECU 24 via the input port, not shown. Some examples of these signals include a signal indicative of the crank position from a crank position sensor 180 that detects the rotational position of the crankshaft 26, a signal indicative of the coolant temperature Tw from a coolant temperature sensor 181 that detects the temperature of the coolant of the engine 22, a signal indicative of the cylinder pressure from a cylinder pressure sensor 182 that detects the pressure inside the combustion chamber 120, a signal indicative of the cam position from a cam position sensor 133 that detects the rotational position of a camshaft included in the valve mechanism 130 that drives the intake valve 131 and the exhaust valve 132, and a signal indicative of the throttle position from a throttle valve position sensor 124 that detects the position of the throttle valve 123. Other examples of signals that are input to the engine ECU 24 via the input port include a signal indicative of the intake air amount GA from an airflow meter 183 that detects the intake air amount as the load of the engine 22, a signal indicative of the intake air temperature Tair from an intake air temperature sensor 184 provided in the intake passage 126, a signal indicative of an intake air negative pressure Pi from an intake air pressure sensor 185 that detects negative pressure in the intake passage 126, a signal indicative of the air-fuel ratio AF from an air-fuel ratio sensor 186 arranged upstream of the exhaust gas control apparatus 141 in the exhaust manifold 140, a signal indicative of the catalyst bed temperature Tcat from a catalyst temperature sensor 187 that detects the temperature of the catalyst bed of the exhaust gas control apparatus 141 (i.e., the temperature of the exhaust gas control catalyst 141c), and a signal indicative of the EGR gas temperature from a temperature sensor 144 in the EGR passage 142. Also, various control signals for driving the engine 22 are output via the output port, not shown. Examples of control signals output from the engine ECU 24 via the output port include a drive signal to a throttle motor 125 that adjusts the position of the throttle valve 123, a drive signal to a fuel injection valve 127, a control signal to an ignition coil 129 that is integrated with an igniter, a control signal to the valve mechanism 130, and a drive signal to the EGR valve 143. Also, the engine ECU 24 calculates the speed Ne of the engine 22 using the crank position from the crank position sensor 180. Further, the engine ECU 24 communicates with the hybrid ECU 70 and controls the operation of the engine 22 according to the control signals from the hybrid ECU 70, as well as outputs data related to the operating state of the engine 22 to the hybrid ECU 70 as necessary.

The power splitting/combining device 30 is a single pinion type planetary gear set that has a sun gear 31 that is a gear with external teeth, a ring gear 32 that is a gear with internal teeth that is arranged concentric with the sun gear 31, and a carrier 34 that pivotally and rotatably retains a plurality of pinion gears 33 that are in mesh with both the sun gear 31 and the ring gear 32, with these three elements, i.e., the sun gear 31, the ring gear 32, and the carrier 34, being able to differentially rotate with respect to one another. The crankshaft 26 of the engine 22 is connected to the carrier 34 which is the first element of the power splitting/combining device 30. A rotating shaft of the motor MG1 is connected to the sun gear 31 that is the second element, and a rotating shaft of the motor MG2 is connected to the ring gear 32 which is the third element via the reduction gear 35 and the ring gear shaft 32a that serves as the drive shaft. When the motor MG1 functions as a generator, the power splitting/combining mechanism 30 distributes the power from the engine 22 that is input from the carrier 34 to the sun gear 31 side and the ring gear 32 side according to the gear ratio of the sun gear 31 and the ring gear 32. When the motor MG1 functions as a motor, the power splitting/combining mechanism 30 combines the power from the engine 22 that is input from the carrier 34 with the power from the motor MG1 that is input from the sun gear 31, and outputs the combined power to the ring gear 32 side. The power output to the ring gear 32 is ultimately output from the ring gear shaft 32a to wheels 39a and 39b, which are driving wheels, via a gear mechanism 37 and a differential gear 38.

The motors MG1 and MG2 are structured as well-known synchronous motor-generators that operates as both a generator and a motor, and send and receive electric power to and from a battery 50, which is a secondary battery, via inverters 41 and 42, respectively. A power line 54 that connects the inverters 41 and 42 to the battery 50 is structured as a positive bus and a negative bus shared by both of the inverters 41 and 42, such that electric power generated by one motor (either the MG1 or the MG2) can be consumed by the other motor. Therefore, the battery 50 is charged by electric power generated by the motor MG1 or MG2 and discharged if the electric power of the motor MG1 or MG2 is insufficient. If the electric power from the motors MG1 and MG2 is balanced, the battery 50 will neither be charged nor discharged. Both of the motors MG1 and MG2 are drivingly controlled by a motor electronic control unit (hereinafter, simply referred to as a “motor ECU”) 40. This motor ECU 40 receives signals necessary for drivingly controlling the motors MG1 and MG2, such as signals from rotational position detecting sensors 43 and 44 that detect the rotational position of the rotors of the motors MG1 and MG2, and the phase current applied to the motors MG1 and MG2 that is detected by current sensors, not shown, and the like. The motor ECU 40 outputs switching control signals to the inverters 41 and 42, and the like. The motor ECU 40 also executes a rotation speed calculating routine, not shown, based on the signals received from the rotational position detecting sensors 43 and 44, and calculates the rotation speeds Nm1 and Nm2 of the rotors of the motors MG1 and MG2. Further, the motor ECU 40 communicates with the hybrid ECU 70 and drivingly controls the motors MG1 and MG2 based on control signals and the like from the hybrid ECU 70, as well as outputs data related to the operating states of the motors MG1 and MG2 to the hybrid ECU 70 when necessary.

The battery 50 is structured as a lithium-ion secondary battery or a nickel-metal hydride secondary battery, and is controlled by a battery electronic control unit (hereinafter, simply referred to as a “battery ECU”) 52. This battery ECU 52 receives signals necessary for controlling the battery 52, such as a signal indicative of the terminal voltage from a voltage sensor, not shown, arranged between the terminals of the battery 50, a signal indicative of the charge-discharge current from a current sensor, not shown, provided in the power line 54 that is connected to an output terminal of the battery 50, and a signal indicative of the battery temperature Tb from a temperature sensor 51 mounted to the battery 50, and the like. The battery ECU 52 communicates with the hybrid ECU 70 and outputs data related to the state of the battery 50 to the hybrid ECU 70 when necessary. Further, to control the battery 50, the battery ECU 52 calculates the state-of-charge (SOC) based on the integrated value of the charge-discharge current detected by the current sensor, calculates the required charge-discharge electric power Pb* of the battery 50 based on that state-of-charge SOC, and calculates an input limit Win as an allowable charge electric power, which is the amount of electric power allowed to be charged to the battery 50, and an output limit Wout as an allowable discharge electric power, which is the amount of electric power allowed to be discharged from the battery 50, based on the state-of-charge SOC and the battery temperature Tb. Incidentally, the input and output limits Win and Wout of the battery 50 are able to be set by first setting basic values for the input and output limits Win and Wout based on the battery temperature Tb, as well as setting an output limit correction coefficient and an input limit correction coefficient based on the state-of-charge SOC of the battery 50, and then multiplying the basic value of the set input limit Win by the input limit correction coefficient to obtain the input limit Win, and multiplying the basic value of the set output limit Wout by the output limit correction coefficient to obtain the output limit Wout.

The hybrid ECU 70 is formed as a microprocessor that is centered around a CPU 72, and includes, in addition to the CPU 72, ROM 74 that stores processing programs, RAM 76 that temporarily stores data, a timer 78 that measures time according to a timekeeping command, and input/output ports and a communication port, not shown, and the like. Signals from various sensors are input via the input port to the hybrid ECU 70. Some examples of these signals include an ignition signal from an ignition switch (i.e., a start switch) 80, a signal indicative of a shift position SP from a shift position sensor 82 that detects the shift position SP which is the operating position of a shift lever 81, a signal indicative of an accelerator operation amount Acc from an accelerator pedal position sensor 84 that detects the depression amount of an accelerator pedal 83, a signal indicative of a brake pedal stroke BS from a brake pedal stroke sensor 86 that detects the depression amount of a brake pedal 85, and a signal indicative of the vehicle speed V from a vehicle speed sensor 87, and the like. As described above, the hybrid ECU 70 is connected to the engine ECU 24, the motor ECU 40, and the battery ECU 52 and the like via the communication port, and sends and receives various control signals and data to and from the engine ECU 24, the motor ECU 40, and the battery ECU 52 and the like.

In the hybrid vehicle 20 of this example embodiment structured as described above, the required torque Tr* to be output to the ring gear shaft 32a that serves as the drive shaft is calculated based on the vehicle speed V and the accelerator operation amount Acc that corresponds to the depression amount of the accelerator pedal 83 by the driver. The engine 22, the motor MG1, and the motor MG2 are controlled such that torque based on this required torque Tr* is output to the ring gear shaft 32a. Some examples of operation control modes of the engine 22, the motor MG1, and the motor MG2 are i) a torque converting operating mode, ii) a charge-discharge operating mode, and iii) a motor operating mode. In the torque converting operating mode, the engine 22 is controlled to output power comparable to the required torque Tr*, and the motor MG1 and the motor MG2 are controlled to output all of the power output from the engine 22 to the ring gear shaft 32a after it has been converted to torque by the power splitting/combining device 30, the motor MG1, and the motor MG2. In the charge-discharge operating mode, the engine 22 is controlled to output power comparable to the sum of the required torque Tr* and the electric power needed to be charged or discharged to or from the battery 50, and the motor MG1 and the motor MG2 are controlled to output torque based on the required torque Tr* to the ring gear shaft 32a after all or some of the power output from the engine 22 with the charge-discharge of the battery 50 is converted to torque by the power splitting/combining device 30, the motor MG1, and the motor MG2. In the motor operating mode, the engine 22 is stopped and the motor MG2 is controlled to output torque based on the required torque Tr* to the ring gear shaft 32a. Also, in the hybrid vehicle 20 of this example embodiment, when a predetermined condition is satisfied in the torque converting operating mode or the charge-discharge operating mode, intermittent operation is executed in which the engine 22 is automatically stopped and started. Furthermore, with the hybrid vehicle 20 in this example embodiment, when the system is started up cold, i.e., when the coolant temperature Tw is equal to or less than a predetermined warm-up execution temperature, the engine 22 is started and basically catalyst warm-up is executed, according to which the engine 22 is operated so that the engine speed Ne becomes a relatively low catalyst warm-up speed New (approximately 1300 rpm, for example) and relatively little power is output (approximately 2 to 3 kW, for example) while the ignition timing is greatly retarded. This increases the temperature of the exhaust gas, which in turn promotes activation of the exhaust gas control catalyst 141c that purifies the exhaust gas from the engine 22. Incidentally, the determination as to whether catalyst warm-up should be executed may of course also be made by comparing the catalyst bed temperature estimated by the engine ECU 24 or the like based on the catalyst bed temperature Tcat from the catalyst temperature sensor 187, the intake air temperature GA from the airflow meter 183, the coolant temperature Tw from the coolant temperature sensor 181, the air-fuel ratio AF from the air-fuel ratio sensor 186, or the retard amount of the ignition timing or the like, with a predetermined reference temperature, instead of using the coolant temperature Tw.

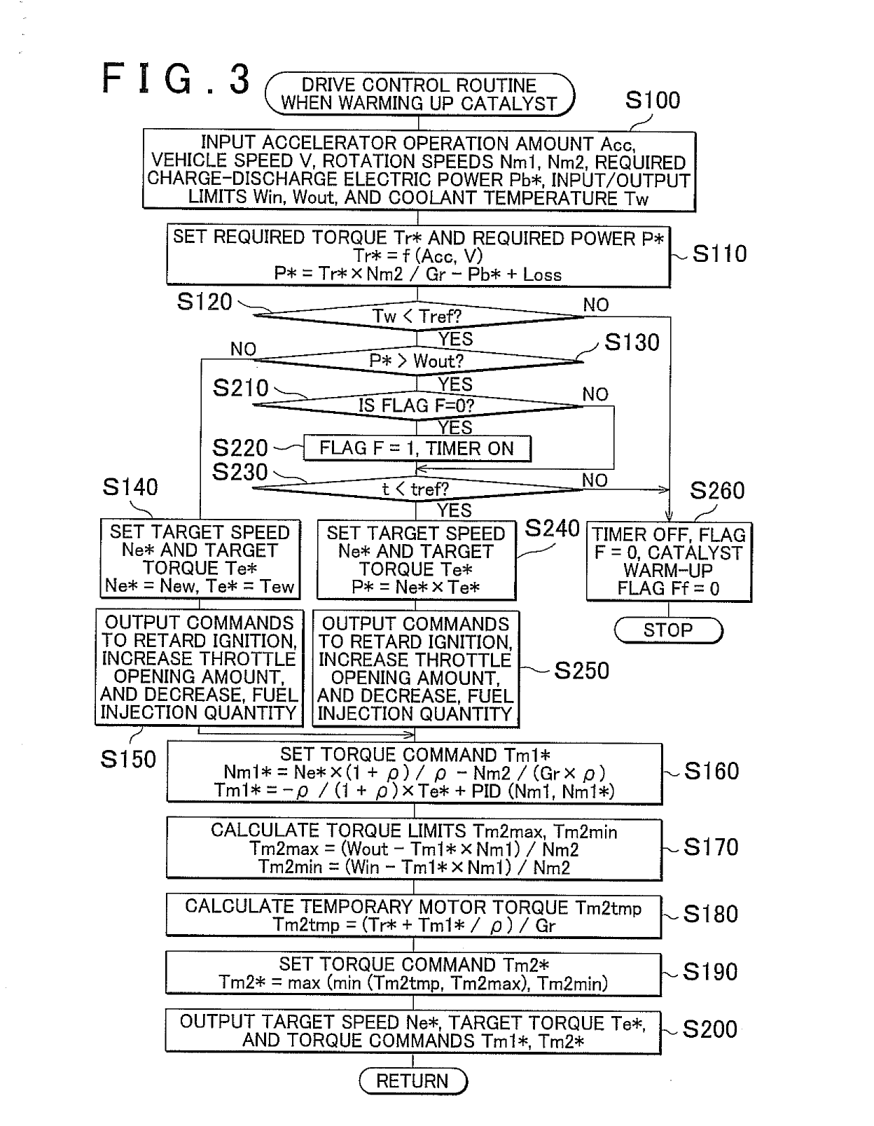

Next, the operation when the foregoing catalyst warm-up operation is executed in the hybrid vehicle in this example embodiment structured as described above will be described. FIG. 3 is a flowchart illustrating one example of a drive control routine during catalyst warm-up that is executed at predetermined intervals of time (such as every several milliseconds) by the hybrid ECU 70 of the example embodiment after the engine 22 has been started, following a command by the engine ECU 24 to execute catalyst warm-up operation, for example.

When the routine in FIG. 3 starts, the CPU 72 of the hybrid ECU 70 inputs data necessary for control, such as the accelerator operation amount Acc from the accelerator pedal position sensor 84, the vehicle speed V from the vehicle speed sensor 87, the rotation speeds Nm1 and Nm2 of the motors MG1 and MG2, the required charge-discharge electric power Pb*, the input and output limits Win and Wout of the battery 50, and the coolant temperature Tw (step S100). Here, the rotation speeds Nm1 and Nm2 of the motors MG1 and MG2 are calculated by the motor ECU 40 based on the signals from the rotational position detecting sensors 43 and 44, and received through communication from the motor ECU 40. Also, the required charge-discharge electric power Pb* and the input and output limits Win and Wout are received through communication from the battery ECU 52. Moreover, the coolant temperature Tw is detected by the coolant temperature sensor 181 and received through communication from the engine ECU 24.

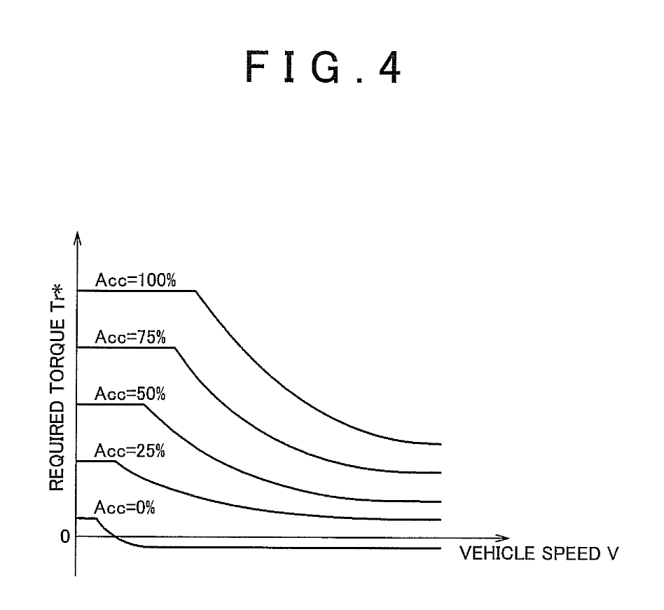

After the data is input in step S100, the required torque Tr* to be output to the ring gear shaft 32a is set based on the input accelerator operation amount Acc and the vehicle speed V, and then the required power P* that is required for the entire vehicle is set (step S110). In this example embodiment, the relationships among the accelerator operation amount Acc, the vehicle speed V, and the required torque Tr* are stored in advance in the ROM 74 in the form of a required torque setting map. A required torque Tr* that corresponds to a given accelerator operation amount Acc and vehicle speed V is calculated and set from the map. FIG. 4 shows an example of a required torque setting map. Also in this example embodiment, the required power P* is calculated as the total sum of the product of the rotation speed Nr of the ring gear shaft 32a multiplied by the set required torque Tr*, the required charge-discharge electric power Pb*, and the loss Loss. That is, the required power P* is the sum of the power needed to output the required torque Tr* to the ring gear shaft 32a which serves as the drive shaft, the electric power needed to be charged or discharged to or from the battery 50, and the loss amount. Incidentally, the rotation speed Nr of the ring gear shaft 32a can be obtained by dividing the rotation speed Nm2 of the motor MG2 by the gear ratio Gr of the reduction gear 35, as shown in the drawing, or by multiplying the vehicle speed V by a conversion coefficient k.

Next, it is determined whether the coolant temperature Tw input in step S100 is less than a predetermined warm-up complete temperature Tref (step S120). This warm-up complete temperature Tref is determined in advance through testing and analysis as a coolant temperature at which it can be regarded that catalyst warm-up is complete. If it is determined in step S120 that the coolant temperature Tw is less than the warm-up complete temperature Tref, then it is determined whether the required power P* set in step S110 exceeds the output limit Wout of the battery 50 input in step S100 (step S130). Here, if the required power P* that is required for the entire vehicle is equal to or less than the output limit Wout, the required power P*, i.e., the power needed to output the required torque Tr* to the ring gear shaft 32a, can be provided by the electric power from the battery 50 so the engine 22 does not have to output a lot of power. Therefore, if it is determined in step S130 that the required power P* is equal to or less than the output limit Wout, the target speed Ne of the engine 22 is set to the catalyst warm-up speed New described above, and the target torque Te* is set to a torque Tew based on that catalyst warm-up speed New and the power (approximately 2 to 3 kW, for example) output from the engine 22 while the catalyst is being warmed up (step S140). Furthermore, command signals to execute a retard correction of the ignition timing of the engine 22, an increase correction of the intake air amount, and a decrease correction of the fuel injection quantity (i.e., the fuel supply amount) are output to the engine ECU 24 in order to increase the temperature of the exhaust gas of the engine 22 to promote activation of the exhaust gas control catalyst 141c (step S150).

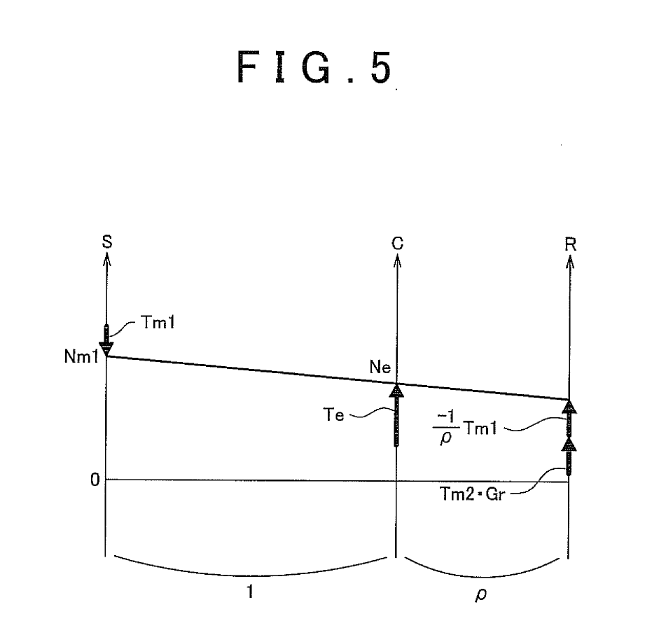

Next, the target rotation speed Nm1* of the motor MG1 is set according to Expression (1) below using the target speed Ne*, the rotation speed Nr (Nm2/Gr) of the ring gear shaft 32a, and the gear ratio ρ (i.e., the number of teeth on the sun gear 31/the number of teeth on the ring gear 32) of the power splitting/combining device 30, and then the torque command Tm1* for the motor MG1 is set according to Expression (2) below using the current rotation speed Nm1 and the like (step S160). Here, Expression (1) is a dynamic relational expression for the rotating elements of the power splitting/combining device 30. FIG. 5 is a view of one example of an alignment graph that shows the dynamic relationship between the rotation speed and torque of rotating elements of the power splitting/combining device 30. In the drawing, the S axis on the left side represents the rotation speed of the sun gear 31 that matches the rotation speed Nm1 of the motor MG1, the C axis in the center represents the rotation speed of the carrier 34 that matches the speed Ne of the engine 22, and the R axis on the right side represents the rotation speed Nr of the ring gear 32, which is equal to the rotation speed Nm2 of the motor MG2 divided by the gear ratio Gr of the reduction gear 35. Also, the two bold arrows on the R axis indicate the torque that acts on the ring gear shaft 32a from the torque output when the torque Tm1 is output by the motor MG1, and the torque that acts on the ring gear shaft 32a via the reduction gear 35 when the torque Tm2 is output by the motor MG2. Expression (1) for obtaining the target rotation speed Nm1* of the motor MG1 can be derived easily using the relationships of the rotation speeds in this alignment graph. Expression (2) is a relational expression of feedback control for operating the motor MG1 at the target rotation speed Nm1*. In Expression (2), the second term on the right, k1, is a proportional term of the gain, and the third term on the right, k2, is an integral term.

Nm1*=Ne*×(1+ρ)/ρ−Nm2/(Gr×ρ) (1)

Tm1*=−ρ/(1+ρ)×Te*+k1×(Nm1*−Nm1)+k2×∫(Nm1−Nm1)dt (2)

Once the torque command Tm1* for the motor MG1 is set, torque limits Tmin and Tmax are calculated according to Expressions (3) and (4) below as upper and lower limits of the torque that is able to be output from the motor MG2, using the input and output limits Win and Wout of the battery 50, the torque command Tm1* for the motor MG1 set in step S210, and the current rotation speeds Nm1 and Nm2 of the motors MG1 and MG2 (step S170). Then, a temporary motor torque Tm2tmp, which is a temporary value of the torque that should be output from the motor MG2, is calculated according to Expression (5) below, using the required torque Tr*, the torque command Tm1*, the gear ratio ρ of the power splitting/combining device 30, and the gear ratio Gr of the reduction gear 35 (step S180). Then the torque command Tm2* for the motor MG2 is set to a value that the temporary motor torque Tm2tmp is limited to by the torque limits Tmin and Tmax (step S190). Setting the torque command Tm2* for the motor MG2 in this way enables the torque that is output to the ring gear shaft 32a to be limited to within the input and output limits Win and Wout of the battery 50. Incidentally, Expression (5) can be easily derived from the alignment graph in FIG. 5. Once the target speed Ne* and target torque Te* of the engine 22 and the torque commands Tm1* and Tm2* for the motors MG1 and MG2 have been set in this way, the target speed Ne* and the target torque Te* are output to the engine ECU 24, and the torque commands Tm1* and Tm2* of the motors MG1 and MG2 are output to the motor ECU 40 (step S200). Then steps S100 and thereafter are executed again.

Tmin=(Win−Tm1*×Nm1)/Nm2 (3)

Tmax=(Wout−Tm1*×Nm1)/Nm2 (4)

Tm2tmp=(Tr*+Tm1*/ρ)/Gr (5)

After receiving the torque commands Tm1* and Tm2*, the motor ECU 40 performs switching control of the switching elements of the inverters 41 and 42 to drive the motor MG1 according to the torque command Tm1* and drive the motor MG2 according to the torque command Tm2*. Also, after receiving the target speed Ne* and the target torque Te*, the engine ECU 24 sets a target intake air amount GA* based on the target speed Ne* and the target torque Te*, and sets a target opening amount TH* of the throttle valve 123 based on that target intake air amount GA*. Then the engine ECU 24 controls the throttle motor 125 based on the throttle position from the throttle valve position sensor 124 so that the opening amount of the throttle valve 123 comes to match the target opening amount TH*. Furthermore, the engine ECU 24 executes fuel injection control, and ignition timing control and the like, as well as this kind of throttle opening amount control. In this case, because the commands to perform the retard correction of the ignition timing, the increase correction of the intake air amount, and the decrease correction of the fuel injection quantity are output in step S150, the engine ECU 24 retards the ignition timing in each combustion chamber 120 by a predetermined amount and increases the target opening amount TH* by a predetermined amount (toward the open side) to increase the intake air amount by a predetermined amount. Moreover, the engine ECU 24 sets the fuel injection timing such that the fuel injection quantity in each combustion chamber 120 (e.g., the fuel injection quantity corresponding to the target opening amount TH* before the increase correction to promote catalyst warm-up) is decreased by a predetermined amount. As a result, the amount of fuel that combusts in the exhaust manifold 140 and in the exhaust gas control catalyst 141c (so-called afterburning) increases, thus enabling the exhaust gas temperature to be increased, which further promotes the activation of the exhaust gas control catalyst 141c.

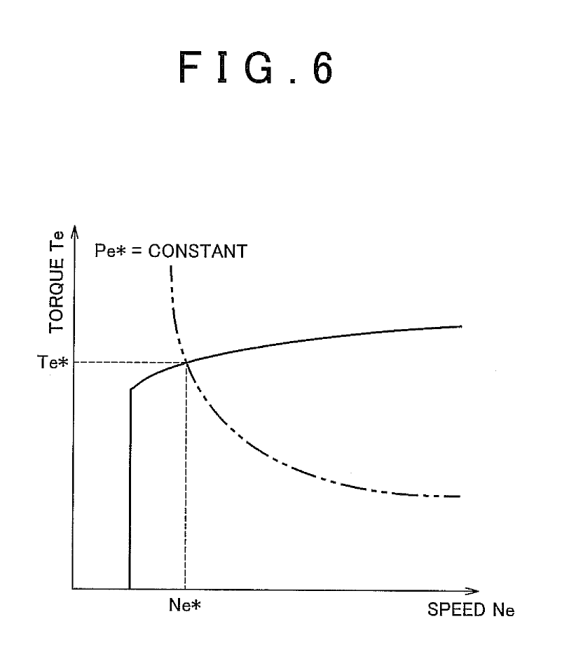

If, on the other hand, it is determined in step S130 that the required power P* exceeds the output limit Wout, then it is determined whether a predetermined flag F is a value of 0 (step S210). If the flag F is a value of 0, then it is set to a value of 1 and the timer 78 is turned on (step S220). Then it is determined whether the elapsed time t measured by the timer 78 is less than a predetermined period of time tref (such as approximately 40 seconds to 1 minute) (step S230). Incidentally, once the flag F is set to a value of 1 in step S220, the next determination in step S210 will be no so step S220 will be skipped. Then if it is determined in step S230 that the elapsed time t is less than the predetermined period of time tref, the target speed Ne* and the target torque Te*, which are the target operating points of the engine 22, are set based on the required power P* (step S240). In this example embodiment, the target speed Ne* and the target torque Te* are set based on the required power P* and a preset operating line so that the engine 22 will operate efficiently. FIG. 6 is a view showing an example of the operating line of the engine 22 and a correlation curve of the speed Ne and the torque Te that shows the required power Pe* as being constant. As shown in the drawing, the target speed Ne* and the target torque Te* can be obtained as the intersection of the operating line and the correlation curve that shows the required power Pe*(Ne*×Te*) as being constant.

Once the target speed Ne* and the target torque Te* of the engine 22 have been set in this way, command signals for executing the retard correction of the ignition timing of the engine 22, the increase correction of the intake air amount, and the decrease correction of the fuel injection quantity are output to the engine ECU 24 to increase the temperature of the exhaust gas of the engine 22 and thus promote the activation of the exhaust gas control catalyst 141c (step S250). Then steps S160 to S190 described above are executed, and the target speed Ne* and the target torque Te* are output to the engine ECU 24, and the torque commands Tm1* and Tm2* of the motors MG1 and MG2 are output to the motor ECU 40 (step S200). Then steps S100 and thereafter are executed again. In this case as well, after receiving the target speed Ne* and the target torque Te*, the engine ECU 24 executes the throttle opening amount control, the fuel injection control, and the ignition timing control and the like. Also, because the commands to perform the retard correction of the ignition timing, the increase correction of the intake air amount, and the decrease correction of the fuel injection quantity are output in step S250, the engine ECU 24 retards the ignition timing in each combustion chamber 120 by a predetermined amount, increases the target opening amount TH* by a predetermined amount (toward the open side) to increase the intake air amount by a predetermined amount, and sets the fuel injection timing such that the fuel injection quantity in each combustion chamber 120 is decreased by a predetermined amount.

In this way, with the hybrid vehicle 20 of this example embodiment, if the required power P* exceeds the output limit Wout when catalyst warm-up needs to be performed to promote the activation of the exhaust gas control catalyst 141c, the required power P*, i.e., the power needed to output the required torque Tr* to the ring gear shaft 32a, is unable to be provided by the electric power from the battery 50. Therefore, the target operating point of the engine 22 is set based on the required power P*, so the output, i.e., the load, of the engine 22 is increased. However, if the load of the engine 22 is increased before catalyst warm-up is complete, the exhaust gas from the engine 22 may not be able to be sufficiently purified by the exhaust gas control catalyst 141c. In light of this, in the hybrid vehicle 20 in this example embodiment, when the required power P* exceeds the output limit Wout when catalyst warm-up needs to be executed, the ignition timing in each combustion chamber 120 is retarded more than the base ignition timing, for example, to further promote activation of the exhaust gas control catalyst 141c, the target opening amount TH* is increased by a predetermined amount (i.e., toward the open side) to increase the intake air amount by a predetermined amount, and the fuel injection timing is set so that the fuel injection quantity in each combustion chamber 120 is decreased by a predetermined amount. As a result, even if the power from the engine 22 is does not quite meet the required power P*, activation of the exhaust gas control catalyst 141c can still be promoted by increasing the exhaust gas temperature of the engine 22, thereby enabling deterioration of the emissions to be suppressed. Incidentally, the amount that the ignition timing is retarded, the amount the throttle opening amount is increased, and the amount that the fuel injection quantity is reduced when the commands to execute the retard correction of the ignition timing, the increase correction of the intake air amount, and the decrease correction of the fuel injection quantity are output in step S250 may be the same as they are when the commands to execute the retard correction of the ignition timing, the increase correction of the intake air amount, and the decrease correction of the fuel injection quantity are output in step S150. However, in this example embodiment, correction amounts that are suitable for the operating point (i.e., the target speed Ne* and the target torque Te*) of the engine 22, for example, are used for these correction amounts.

If it is determined in step S120 that the coolant temperature Tw is equal to or greater than the warm-up complete temperature Tref, the timer 78 is turned off and the flag F is set to a value of 0. Furthermore, when there is a command from the engine ECU 24 to execute catalyst warm-up, the hybrid ECU 70 sets the catalyst warm-up flag Ff that is set to a value of 1 to a value of 0 (step S260), after which this cycle of the routine ends. Also, even if the coolant temperature Tw is less than the warm-up complete temperature Tref, if it is determined in step S230 that the elapsed time t measured by the timer 78 is equal to or great than the predetermined period of time tref, step S260 is executed, after which this cycle of the routine ends. After the routine ends in this way, a drive control routine for normal engine operation is executed.

With the hybrid vehicle 20 of this example embodiment described above, if the required power P* is equal to or less than the output limit Wout, which is the allowable discharge electric power, when catalyst warm-up needs to be executed to promote activation of the exhaust gas control catalyst 141c, the engine 22 is operated at the predetermined catalyst warm-up operating point (i.e., at the catalyst warm-up speed New and torque corresponding to this catalyst warm-up speed New) with the retard correction of the ignition timing, the increase correction of the intake air amount, and the decrease correction of the fuel supply amount, while the engine 22 and the motors MG1 and MG2 are controlled so that torque based on the required torque Tr* is output to the ring gear shaft 32a that serves as the drive shaft (steps S140 to S200). In contrast, if the required power P* is greater than the output limit Wout when catalyst warm-up needs to be executed, the engine 22 is operated at an operating point that is based on the required power P* with the retard correction of the ignition timing, the increase correction of the intake air amount, and the decrease correction of the fuel supply amount, while the engine 22 and the motors MG1 and MG2 are controlled so that torque based on the required torque Tr* is output to the ring gear shaft 32a that serves as the drive shaft (steps S240, S250, and S160 to S200). In this way, if the required power P* exceeds the output limit Wout such that the required power P* is no longer able to be provided by the electric power from the battery 50 when catalyst warm-up needs to be executed, activation of the catalyst can be promoted, which enables the deterioration of emissions to be suppressed, even if the power from the engine 22 does not quite meet the required power P*, by increasing the exhaust gas temperature of the engine 22, which is achieved by operating the engine 22 at an operating point that is based on the required power P* with the retard correction of the ignition timing, the increase correction of the intake air amount, and the decrease correction of the fuel supply amount.

Also, with the hybrid vehicle 20 in this example embodiment, when the required power P* exceeds the output limit Wout while the engine 22 is in the middle of operating at the catalyst warm-up operating point in order to warm up the catalyst, a retard correction of the ignition timing and the like is executed before and after the point at which the required power P* exceeds the output limit Wout. As a result, activation of the catalyst can be promoted by increasing the exhaust gas temperature of the engine 22, so deterioration of emissions can be suppressed even if the load of the engine 22 is increased after catalyst warm-up is complete. However, in order to promote activation of the exhaust gas control catalyst 141c, it is not necessary to execute all of the corrections, i.e., the retard correction of the ignition timing, the increase correction of the intake air amount, and the decrease correction of the fuel supply amount. That is, activation of the exhaust gas control catalyst 141c will be promoted if at least one or two of these corrections are made.

Moreover, in this example embodiment, if the coolant temperature Tw is less than the warm-up complete temperature Tref and the required power P* exceeds the output limit Wout when catalyst warm-up needs to be executed, the retard correction of the ignition timing, the increase correction of the intake air amount, and the decrease correction of the fuel supply amount are executed from the time the required power P* exceeds the output limit Wout until a predetermined period of time tref has passed. That is, once the predetermined period of time tref has passed after the required power P* has exceeded the output limit Wout, the exhaust gas control catalyst 141c can be regarded as being substantially activated by the retard correction of the ignition timing and the like, even if the coolant temperature Tw is less than the warm-up complete temperature Tref. Therefore, canceling the retard correction of the ignition timing and the like at that point inhibits the output of the engine 22 from being limited more than is necessary. Also, setting the catalyst warm-up operating point to an operating point at which the speed Ne of the engine 22 becomes a relative low catalyst warm-up speed New (such as approximately 1300 rpm, for example) and the engine 22 outputs a relatively small amount of power (such as 2 to 3 kW, for example) enables the engine 22 to be operated more appropriately to promote the activation of the catalyst when catalyst warm-up needs to be executed. However, the operating point of the engine 22 to warm up the catalyst may also be set to an operating point at which the speed Ne of the engine 22 is a relatively low speed (such as approximately 900 to 1200 rpm, for example) and the engine 22 essentially does not output any torque (i.e., a self-sustaining operating point).

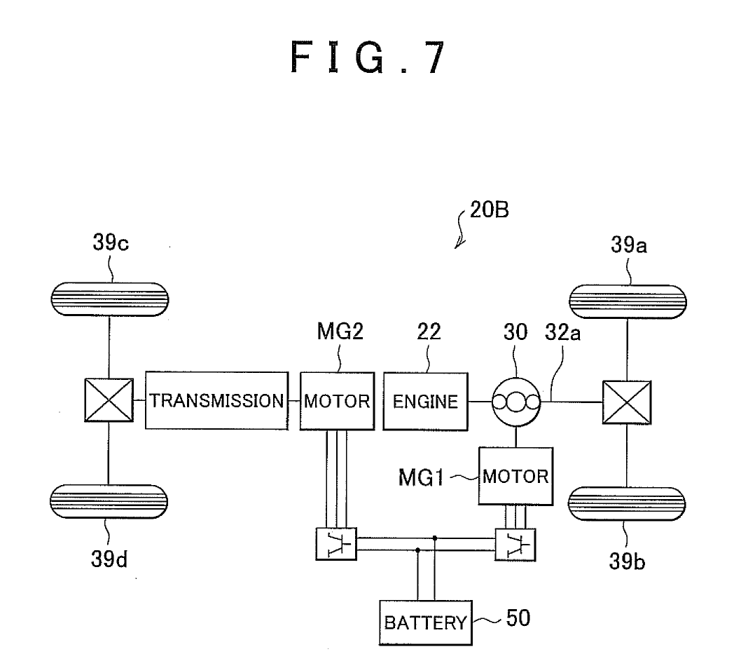

Incidentally, in the hybrid vehicle 20 of this example embodiment, the ring gear shaft 32a that serves as the drive shaft is connected to the motor MG2 via the reduction gear 35 that reduces the rotation speed of the MG2 and transmits that reduced rotation speed to the ring gear shaft 32a. However, instead of the reduction gear 35, a transmission may also be employed that has two speeds, such as Hi and Lo, or three or more speeds, and changes the rotation speed of the motor MG2 and transmits the changed rotation speed to the ring gear shaft 32a. Moreover, the hybrid vehicle 20 of this example embodiment outputs the power of the motor MG2 to the ring gear shaft 32a that is connected to the ring gear 32 of the power splitting/combining device 30. However, the invention is not limited to this structure. That is, the invention may also be applied to a structure that outputs the power of the motor MG2 to a shaft other than the ring gear shaft 32a (i.e., the wheels 39a and 39b), as in a hybrid vehicle 20B according to a modified example shown in FIG. 7.

The invention will be summarized below.

One aspect of the invention relates to a power output apparatus that outputs power to a drive shaft. This power output apparatus includes an internal combustion engine capable of outputting power to the drive shaft; an exhaust gas control apparatus that includes a catalyst for purifying exhaust gas discharged from the internal combustion engine; an electric motor capable of outputting power to the drive shaft; a power storage device capable of supplying and receiving electric power to and from the electric motor; a required torque setting portion that sets a required torque that is required at the drive shaft; a required power setting portion that sets a required power that is power required to output the required torque to the drive shaft, based on the set required torque; an allowable discharge electric power setting portion that sets an allowable discharge electric power that is allowed to be discharged by the power storage device, based on the state of the power storage device; and a control portion that controls the internal combustion engine and the electric motor such that the internal combustion engine is operated at a preset catalyst warm-up operating point and torque that is based on the set required torque is output to the drive shaft, when the set required power is equal to or less than the set allowable discharge electric power when catalyst warm-up to promote activation of the catalyst needs to be executed, and controls the internal combustion engine and the electric motor such that the internal combustion engine is operated at an operating point that is based on the set required power with at least one of i) a retard correction of the ignition timing, ii) an increase correction of the intake air amount, or iii) a decrease correction of the fuel supply amount, and torque that is based on the set required torque is output to the drive shaft, when the set required power exceeds the set allowable discharge electric power when the catalyst warm-up needs to be executed.

Also, the control portion may control the internal combustion engine to operate at the catalyst warm-up operating point with the retard correction of the ignition timing when the set required power is equal to or less than the set allowable discharge electric power when the catalyst warm-up needs to be executed, and control the internal combustion engine to operate at an operating point that is based on the set required power with the same retard correction of the ignition timing as when the required power is equal to or less than the allowable discharge electric power or a different retard correction of the ignition timing than when the required power is equal to or less than the allowable discharge electric power, when the set required power exceeds the set allowable discharge electric power when the catalyst warm-up needs to be executed. Accordingly, when the required power exceeds the allowable discharge electric power while the internal combustion engine is in the middle of operating at the catalyst warm-up operating point to warm up the catalyst, the retard correction of the ignition timing is executed before and after the point at which the required power exceeds the allowable discharge electric power. As a result, activation of the catalyst can be promoted by increasing the exhaust gas temperature of the internal combustion engine, so deterioration of emissions can be suppressed even if the load of the internal combustion engine is increased before the catalyst has finished warming up.

Furthermore, the control portion may execute at least one of the retard correction of the ignition timing, the increase correction of the intake air amount, or the decrease correction of the fuel supply amount from after the required power exceeds the allowable discharge electric power until a cancellation condition that includes a predetermined period of time having passed is satisfied, when the set required power exceeds the set allowable discharge electric power when the catalyst warm-up needs to be executed. In this way, canceling the retard correction of the ignition timing and the like for activating the catalyst at the point when the predetermined period of time has passed after the required power has exceeded the allowable discharge electric power makes it possible to suppress the output of the internal combustion engine from being limited more than necessary.

Also, the catalyst warm-up operating point may be an operating point at which the speed of the internal combustion engine is a relatively low predetermined speed and the internal combustion engine outputs a relatively small amount of power. Accordingly, the engine is able to be operated more appropriately to promote the activation of the catalyst when catalyst warm-up needs to be executed.

The power output apparatus may also include a second electric motor capable of inputting and outputting power, as well as supplying and receiving electric power to and from the power storage device; and a planetary gear set that has a first element that is connected to an output shaft of the internal combustion engine, a second element that is connected to a rotating shaft of the second electric motor, and a third element that is connected to the drive shaft, the planetary gear set being structured such that these three elements are able to differentially rotate with respect to one another. Also, the control portion may control the internal combustion engine, the electric motor, and the second electric motor such that the internal combustion engine is operated at the catalyst warm-up operating point and torque that is based on the set required torque is output to the drive shaft, when the set required power is equal to or less than the set allowable discharge electric power when the catalyst warm-up needs to be executed, and control the internal combustion engine, the electric motor, and the second electric motor such that the internal combustion engine is operated at an operating point that is based on the set required power with at least one of i) the retard correction of the ignition timing, ii) the increase correction of the intake air amount, or iii) the decrease correction of the fuel supply amount, and torque that is based on the set required torque is output to the drive shaft, when the set required power exceeds the set allowable discharge electric power when the catalyst warm-up needs to be executed.

Another aspect of the invention relates to a hybrid vehicle that includes any one of the power output apparatuses described above and a driving wheel that is connected to the drive shaft. Therefore, with this hybrid vehicle, deterioration of emissions is able to be suppressed by promoting the activation of the catalyst even if the required power is not able to be met by the electric power from the power storage device and the load of the internal combustion engine is increased when catalyst warm-up needs to be executed.

Yet another aspect of the invention relates to a control method of a power output apparatus. Here, the power output apparatus is provided with a drive shaft, an internal combustion engine capable of outputting power to the drive shaft, an exhaust gas control apparatus that includes a catalyst for purifying exhaust gas discharged from the internal combustion engine, an electric motor capable of outputting power to the drive shaft, and a power storage device capable of supplying and receiving electric power to and from the electric motor. This control method includes setting a required torque that is required at the drive shaft; setting a required power that is power required to output the required torque to the drive shaft, based on the set required torque; setting an allowable discharge electric power that is allowed to be discharged by the power storage device, based on the state of the power storage device; and controlling the internal combustion engine and the electric motor such that the internal combustion engine is operated at a preset catalyst warm-up operating point and torque that is based on the set required torque is output to the drive shaft, when the set required power is equal to or less than the set allowable discharge electric power when catalyst warm-up to promote activation of the catalyst needs to be executed, and controlling the internal combustion engine and the electric motor such that the internal combustion engine is operated at an operating point that is based on the set required power with at least one of i) a retard correction of the ignition timing, ii) an increase correction of the intake air amount, or iii) a decrease correction of the fuel supply amount, and torque that is based on the set required torque is output to the drive shaft, when the set required power exceeds the set allowable discharge electric power when the catalyst warm-up needs to be executed.

In the example embodiments and modified examples described above, the engine 22 that is capable of outputting power to the ring gear shaft 32 that serves as the drive shaft may be regarded as the internal combustion engine of the invention. The exhaust gas control apparatus 141 that includes the exhaust gas control catalyst 141c for purifying exhaust gas discharged from the engine 22 may be regarded as the exhaust gas control apparatus of the invention. The motor MG2 that is capable of outputting power to the ring gear shaft 32a may be regarded as the electric motor of the invention. The battery 50 capable of supplying and receiving electric power to and from the motor MG2 may be regarded as being the power storage device of the invention. The hybrid ECU 70 that executes the process in step S110 in FIG. 3 may be regarded as the required torque setting portion and the required power setting portion of the invention. The battery ECU 52 that sets the output limit Wout, which is the amount of electric power allowed to be discharged from the battery 50, based on the state-of-charge SOC and the battery temperature Tb may be regarded as the allowable discharge electric power setting portion of the invention. The combination of the hybrid ECU 70, the engine ECU 24, and the motor ECU 40 that control the engine 22, the motor MG1, and the motor MG2 such that the engine 22 is operated at a preset catalyst warm-up operating point and torque that is based on the required torque Tr* is output to the ring gear shaft 32a when the required power P* is equal to or less than the output limit Wout when catalyst warm-up that promotes the activation of the exhaust gas control catalyst 141c needs to be executed, and controls the engine 22, the motor MG1, and the motor MG2 such that the engine 22 is operated at an operation point that is based on the required power P* with at least one of a retard correction of the ignition timing, an increase correction of the intake air amount, or a decrease correction of the fuel supply amount and torque that is based on the required torque Tr* is output to the ring gear shaft 32a when the required power P* exceeds the output limit Wout when catalyst warm-up needs to be executed, may be regarded as the control portion of the invention. The motor MG1 that is capable of receiving and outputting power as well as supplying and receiving electric power to and from the battery 50 may be regarded as the second electric motor of the invention. The power splitting/combining device 30 that has the carrier 34 that is connected to the crankshaft 26 of the engine 22, the sun gear 31 that is connected to the rotating shaft of the motor MG1, and the ring gear 32 that is connected to the ring gear shaft 32a that serves as the drive shaft, and is structured such that these three elements are able to differentially rotate with respect to one another may be regarded as the planetary gear set of the invention.

However, the internal combustion engine is not limited to the engine 22 that receives a supply of hydrocarbon fuel such as gasoline or light oil and outputs power. That is, the internal combustion engine may be another type of engine such as a hydrogen engine. The exhaust gas control apparatus may be any type of exhaust gas control apparatus as long as it includes an exhaust gas control catalyst for purifying exhaust gas discharged from the engine 22. The electric motor and the second electric motor are not limited to being synchronous motor-generators like the motors MG1 and MG2, but may be another type of electric motor such as an induction motor. The power storage device is not limited to being a secondary motor like the battery 50, but may also take another form such as a capacitor as long as it is able to supply and receive electric power to and from the electric motor. The required torque setting portion is not limited to a structure that sets the required torque based on the accelerator operation amount and the vehicle speed, but may take another form such as a structure that sets the required driving force based on only the accelerator operation amount, for example. The required power setting portion may also take any form as long as it sets the power required to output the required torque to the drive shaft, based on the set required torque. The control portion may also take a form other than the combination of the hybrid ECU 70, the engine ECU 24, and the motor ECU 40, such as a single electronic control unit.

The invention is able to be used in the manufacturing industry of power output apparatuses and hybrid vehicles and the like.

While the invention has been described with reference to example embodiments thereof, it is to be understood that the invention is not limited to the described embodiments or constructions. The invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A power output apparatus that outputs power to a drive shaft, comprising:
an internal combustion engine that outputs power to the drive shaft;
an exhaust gas control apparatus that includes a catalyst for purifying exhaust gas discharged from the internal combustion engine;
an electric motor that outputs power to the drive shaft;
a power storage device that supplies and receives electric power to and from the electric motor;
a required torque setting portion that sets a required torque that is required at the drive shaft;
a required power setting portion that sets a required power that is power required to output the required torque to the drive shaft, based on the set required torque;
an allowable discharge electric power setting portion that sets an allowable discharge electric power that is allowed to be discharged by the power storage device, based on the state of the power storage device; and
a control portion that controls the internal combustion engine and the electric motor such that the internal combustion engine is operated at a preset catalyst warm-up operating point and torque that is based on the set required torque is output to the drive shaft, when the set required power is equal to or less than the set allowable discharge electric power when catalyst warm-up to promote activation of the catalyst needs to be executed, and controls the internal combustion engine and the electric motor such that the internal combustion engine is operated at an operating point that is based on the set required power with at least one of i) a retard correction of an ignition timing, ii) an increase correction of an intake air amount, or iii) a decrease correction of a fuel supply amount, and torque that is based on the set required torque is output to the drive shaft, when the set required power exceeds the set allowable discharge electric power when the catalyst warm-up needs to be executed.

2. The power output apparatus according to claim 1, wherein the control portion controls the internal combustion engine to operate at the catalyst warm-up operating point with the retard correction of the ignition timing when the set required power is equal to or less than the set allowable discharge electric power when the catalyst warm-up needs to be executed, and controls the internal combustion engine to operate at an operating point that is based on the set required power with the same retard correction of the ignition timing as when the required power is equal to or less than the allowable discharge electric power or a different retard correction of the ignition timing than when the required power is equal to or less than the allowable discharge electric power, when the set required power exceeds the set allowable discharge electric power when the catalyst warm-up needs to be executed.

3. The power output apparatus according to claim 1, wherein the control portion executes at least one of the retard correction of the ignition timing, the increase correction of the intake air amount, or the decrease correction of the fuel supply amount from after the required power exceeds the allowable discharge electric power until a cancellation condition that includes a predetermined period of time having passed is satisfied, when the set required power exceeds the set allowable discharge electric power when the catalyst warm-up needs to be executed.

4. The power output apparatus according to claim 1, wherein the catalyst warm-up operating point is an operating point at which the speed of the internal combustion engine is a relatively low predetermined speed and the internal combustion engine outputs a relatively small amount of power.

5. The power output apparatus according to claim 1, wherein the catalyst warm-up operating point is an operating point at which the speed of the internal combustion engine is a predetermined speed that is lower than the speed of the internal combustion engine during normal operation and the internal combustion engine outputs less power than the internal combustion engine outputs during normal operation.

6. The power output apparatus according to claim 1, wherein the catalyst warm-up operating point is an operating point at which the speed of the internal combustion engine is approximately 1300 rpm and the internal combustion engine outputs two to three kilowatts.

7. The power output apparatus according to claim 1, wherein the catalyst warm-up operating point is an operating point at which the speed of the internal combustion engine is approximately 900 to 1200 rpm and the internal combustion engine essentially does not output any torque.

8. The power output apparatus according to claim 1, further comprising:
a second electric motor that inputs and outputs power, as well as supplying and receiving electric power to and from the power storage device; and
a planetary gear set that has a first element that is connected to an output shaft of the internal combustion engine, a second element that is connected to a rotating shaft of the second electric motor, and a third element that is connected to the drive shaft, the planetary gear set being structured such that these three elements are able to differentially rotate with respect to one another,
wherein the control portion controls the internal combustion engine, the electric motor, and the second electric motor such that the internal combustion engine is operated at the catalyst warm-up operating point and torque that is based on the set required torque is output to the drive shaft, when the set required power is equal to or less than the set allowable discharge electric power when the catalyst warm-up needs to be executed, and controls the internal combustion engine, the electric motor, and the second electric motor such that the internal combustion engine is operated at the operating point that is based on the set required power with at least one of i) the retard correction of the ignition timing, ii) the increase correction of the intake air amount, or iii) the decrease correction of the fuel supply amount, and torque that is based on the set required torque is output to the drive shaft, when the set required power exceeds the set allowable discharge electric power when the catalyst warm-up needs to be executed.

9. A hybrid vehicle comprising:
the power output apparatus according to claim 1; and
a driving wheel that is connected to the drive shaft.

10. A control method of a power output apparatus provided with a drive shaft, an internal combustion engine that outputs power to the drive shaft, an exhaust gas control apparatus that includes a catalyst for purifying exhaust gas discharged from the internal combustion engine, an electric motor that outputs power to the drive shaft, and a power storage device that supplies and receives electric power to and from the electric motor, comprising:
setting a required torque that is required at the drive shaft;
setting a required power that is power required to output the required torque to the drive shaft, based on the set required torque;
setting an allowable discharge electric power that is allowed to be discharged by the power storage device, based on the state of the power storage device; and
controlling the internal combustion engine and the electric motor such that the internal combustion engine is operated at a preset catalyst warm-up operating point and torque that is based on the set required torque is output to the drive shaft, when the set required power is equal to or less than the set allowable discharge electric power when catalyst warm-up to promote activation of the catalyst needs to be executed, and controlling the internal combustion engine and the electric motor such that the internal combustion engine is operated at an operating point that is based on the set required power with at least one of i) a retard correction of an ignition timing, ii) an increase correction of an intake air amount, or iii) a decrease correction of a fuel supply amount, and torque that is based on the set required torque is output to the drive shaft, when the set required power exceeds the set allowable discharge electric power when the catalyst warm-up needs to be executed.
